(19) United States
(12) Patent Application Publication
(10) Pub. No.: US 2010/0061603 A1
(43) Pub. Date: Mar. 11, 2010

(54) SPATIALLY VARYING 2D IMAGE PROCESSING BASED ON 3D IMAGE DATA

(75) Inventors: Pieter Maria Mielekamp, Eindhoven (NL); Robert Johnnes Frederik Homan, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 12/305,997

(22) PCT Filed: Jun. 18, 2007
(86) PCT No.: PCT/IB2007/052328

§ 371 Date: Oct. 23, 2009

(30) Foreign Application Priority Data
Jun. 28, 2006 (EP) 06116185.7

(51) Int. Cl. G06T 7/00

(52) U.S. Cl. 382/128; 382/254

(57) ABSTRACT

It is described a 2D image processing of an object under examination in particular for enhancing the visualization of an image composition between the 2D image and a 3D image. Thereby, (a) a first dataset representing a 3D image of the object is acquired, (b) a second dataset representing the 2D image of the object is acquired, (c) the first dataset and the second dataset are registered and (d) the 2D image is processed. Thereby, based on image information of the 3D image, within the 2D image processing there is at least identified a first region (231, 331) and a second region being spatially different from the first region (231, 331), and the first region (231, 331) and the second region are processed in a different manner. An improved visibility for 3D roadmapping can be achieved by means of image coloring and other 2D-image processing procedures such as contrast/brightness settings, edge-enhancement, noise reduction and feature extraction, wherein these 2D image processing is diversified separately for multiple regions of pixels, such as inside and outside a vessel lumen (231, 331).

The present invention generally relates to the field of digital image processing, in particular for medical purposes in order to enhance the visualization for a user.

Specifically, the present invention relates to a method for processing a two-dimensional image of an object under examination, in particular for enhancing the visualization of an image composition between the two-dimensional image and a three-dimensional image.

Further, the present invention relates to a data processing device and to a catheterization laboratory for processing a two-dimensional image of an object under examination, in particular for enhancing the visualization of an image composition between the two-dimensional image and a three-dimensional image.

Furthermore, the present invention relates to a computer-readable medium and to a program element having instructions for executing the above-mentioned method for processing a two-dimensional image of an object under examination, in particular for enhancing the visualization of an image composition between the two-dimensional image and a three-dimensional image.

In many technical applications, the problem occurs of making a subject visible that has penetrated into an object with respect to its position and orientation within the object. For example in medical technology, a problem of this sort is the treatment of tissue from inside a living body using a catheter, which is to be guided by a physician to the point of the tissue to be examined in a manner that is as precise and closely monitored as possible. As a rule, guidance of the catheter is accomplished using an imaging system, for example a C-arm X-ray apparatus with which fluoroscopic images can be obtained of the interior of the body of the living object, wherein these fluoroscopic images indicate the position and orientation of the catheter relative to the tissue to be examined.

In particular three-dimensional (3D) roadmapping, where two-dimensional (2D) live fluoroscopic images are registered, aligned and projected over a prerecorded 3D representation of the object under examination, is a very convenient method for a physician to monitor the insertion of a catheter into the living object within the 3D surrounding of the object. In this way, the current position of the catheter relative to the tissue to be examined can be visualized and measured.

US 2001/0029334 A1 discloses a method for visualizing the position and the orientation of a subject that is penetrating or that has penetrated into an object. Thereby, a first set of image data are produced from the interior of the object before the subject has penetrated into the object. A second set of image data are produced from the interior of the object during or after the penetration of the subject into the object. Then, the sets of image data are connected and superimposed to form a fused set of image data. An image obtained from the fused set of image data is displayed.

U.S. Pat. No. 6,317,621 B1 discloses a method and an apparatus for catheter navigation in 3D vascular tree exposures, in particularly for inter-cranial application. The catheter position is detected and mixed into the 3D image of the pre-operatively scanned vascular tree reconstructed in a navigation computer. An imaging (registering) of the 3D patient coordination system ensues on the 3D image coordination system prior to the intervention using a number of markers placed on the patient's body, the position of these markers being registered by the catheter. The markers are detected in at least two 2D projection images, produced by a C-arm X-ray device, from which the 3D angiogram is calculated. The markers are projected back on to the imaged subject in the navigation computer and are brought into relation to the marker coordinates in the patient coordinate system, using projection matrices applied to the respective 2D projection images, wherein these matrices already have been determined for the reconstruction of the 3D volume set of the vascular tree.

WO 03/045263 A2 discloses a viewing system and method for enhancing objects of interest represented on a moving background in a sequence of noisy images and for displaying the sequence of enhanced images. The viewing system comprises (a) extracting means for extracting features related to an object of interest in images of the sequence, (b) registering means for registering the features related to the object of interest with respect to the image referential, yielding registered images, (c) similarity detection means for determining the resemblance of the representations of a registered object of interest in succeeding images and (d) weighing means for modulating the intensities of the pixels of said object of interest over the images of the sequence. The viewing system further comprises (e) temporal integrating means for integrating the object of interest and the background over a number, or at least two, registered images of the sequence and (f) display means for displaying the processed images of the enhanced registered object of interest on faded background.

In order not to exposure a patient to a high X-ray load live fluoroscopic images typically contain a lot of noise. Further, the often contain distracting background information. Therefore, a disadvantage of known 3D roadmapping procedures is that the distracting background information typically makes the superposition of a prerecorded 3D image and the live 2D fluoroscopic image unreliable. There may be a need for 2D image processing which allows for performing reliable 3D roadmapping visualization.

This need may be met by the subject matter according to the independent claims. Advantageous embodiments of the present invention are described by the dependent claims.

According to a first aspect of the invention there is provided a method for processing a two-dimensional image of an object under examination, in particular for enhancing the visualization of an image composition between the two-dimensional (2D) image and a three-dimensional (3D) image. The provided method comprising the steps of (a) acquiring a first dataset representing a 3D image of the object, (b) acquiring a second dataset representing a 2D image of the object, (c) registering the first dataset and the second dataset and (d) processing the 2D image. Thereby, based on image information of the 3D image within the 2D image processing, there is at least identified a first region and a second region being spatially different from the first region, and the first region and the second region are processed in a different manner.

This aspect of the invention is based on the idea that the image processing of the 2D image may be optimized by spatially separating the image processing with respect to different regions. For the separation process image information is used, which image information is extracted from the first dataset respectively the 3D image. In other words, image enhancement operations can be bound to respectively parameterized for specific target regions of the 2D image. The information, which is necessary for an appropriate fragmentation of the different target regions is extracted from the 3D image of the object under examination. Of course, before defining the different target regions the first and the second datasets have to be registered.

The described method is in particular applicable in the situation of time independent respectively steady backgrounds. Such situations frequently occur for instance in inter-arterial neuro- and abdominal interventions by means of catheterization.

The registering is preferably carried out by means of known machine based 2D/3D registration procedures. The image processing may be carried out by means of a known graphic processing unit preferably using graphics hardware. Standard graphics hardware may be used.

According to an embodiment of the present invention the method further comprises the step of overlaying the 3D image with the processed 2D image. By using the spatial separated processed 2D image an improved 3D visualization may be obtained showing both image features, which are visible preferably in the 3D image, and image features, which are visible preferably in the 2D image.

According to a further embodiment of the invention the first dataset is acquired by means of computed tomography (CT), computed tomography angiography (CTA), 3D rotational angiography (3D RA), magnetic resonance angiography (MRA) and/or 3D ultrasound (3D US). In case of monitoring an interventional procedure, wherein a catheter is inserted into the object of interest, these examination procedures are preferably carried out before the interventional procedure such that a detailed and precise 3D representation of the object under study may be generated.

In particular if different features of the object are visible predominantly by means of different 3D examination methods, these examination procedures may also be used in combination. Of course, when using combined 3D information from different 3D imaging modalities the corresponding datasets must also be registered with each other.

It has to be pointed out that the first dataset may be acquired in the presence or in the absence of a contrast medium within the object.

According to a further embodiment of the invention the second dataset is acquired in real time during an interventional procedure. This may provide the advantage that a real time 3D roadmapping may be realized, which comprises an improved visualization, such that a physician is able to monitor the interventional procedure by means of live images showing clearly the internal 3D morphology of the object under examination. Thereby, the interventional procedure may comprise the use of an examination and/or an ablating catheter.

Preferably, the second dataset is acquired by means of live 2D fluoroscopy imaging, which allows for an easy and a convenient acquisition of the second dataset representing the 2D image, which is supposed to be image processed in a spatial varying manner.

According to a further embodiment of the invention the step of processing the 2D image comprises applying different coloring, changing the contrast, changing the brightness, applying a feature enhancement procedure, applying an edge enhancement procedure, and/or reducing the noise separately for image pixels located within the first region and for image pixels located within the second region.

This has the advantage that a variety of different known image processing procedures may be used in order to process the 2D image in an optimal way. Of course, these image-processing procedures may be applied respectively carried out separately or in any suitable combination and/or in any suitable sequence.

According to a further embodiment of the invention the object under examination is at least a part of a living body, in particular the object under examination is an internal organ of a patient. This may provide the advantage that interventional material such as guide-wires, stents or coils may be monitored as it is inserted into the living body.

According to a further embodiment of the invention the first region is assigned to the inside of a vessel lumen and the second region is assigned to the outside of a vessel lumen. Such a spatially different 2D image processing for pixels representing the inside and for pixels representing the outside of the vessel lumen may provide the advantage that depending on the features, which are predominantly supposed to be visualized, for each region an optimized image processing may be accomplished.

According to a further embodiment of the invention at least a part of image information of the second region is removed. This is in particular beneficial when the relevant respectively the interesting features of the 2D image are located exclusively within the first region. When the first region is assigned to the inside of the vessel lumen the 2D information outside the vessel lumen may be blanked out such that only structures within the vessel tree remain visible in the 2D image. Such a type of 2D image processing is in particular advantageous in connection with interventional procedures since clinically interesting interventional data are typically contained within the vessel lumen. By using the hardware stencil buffer of a known graphic processing unit the area outside or the area inside a typically irregular shaped projected vessel can be masked out in real time. Further, non-interesting parts of the vessel tree can also be cut away manually.

According to a further embodiment of the invention the contrast of the second region is reduced. Specifically, when the first region is assigned to the inside of the vessel lumen and the second region is assigned to the outside of the vessel lumen, the contrast of the 2D image outside the vessel lumen may be reduced by means of a user selectable fraction. This may be in particular advantageous if the 2D image information surrounding the vessel tree has to be used for orientation purposes.

In this respect it is pointed out that the second dataset representing the 2D image is typically acquired by means of a C-arm, which is moved around the object of interest during an interventional procedure. This requires continuous remask operations, which are often hampered by the matter of fact that interventional material being moved within the object has already been brought into the object.

According to a further embodiment of the invention the image information of the 3D image is a segmented 3D volume information. This means that the 3D image is segmented in appropriate 3D volume information before it is used in order to control the 2D image processing for the target regions.

By using the stencil functionality in combination with Alpha Testing (pixel coverage) hardware, the target regions are labeled during the rendering step of the 3D volume/graphics information. In this way regions can be labeled using different volume presentations modes, including surface and volume rendering.

It has to be pointed out that also combinations of presentation/processing modes are possible. For instance tagging different labels to pre-segmented surface/volume rendered aneurysm and to volume/surface rendered vessel info, will allow for different processing of coils and stents/guidewires.

According to a further aspect of the invention there is provided a data processing device for processing a 2D image of an object under examination, in particular for enhancing the visualization of an image composition between the 2D image and a 3D image. The data processing device comprises (a) a data processor, which is adapted for performing exemplary embodiments of the above-described method and (b) a memory for storing the first dataset representing the 3D image of the object and the second dataset representing the 2D image of the object.

According to a further aspect of the invention there is provided a catheterization laboratory comprising the above-described data processing device.

According to a further aspect of the invention there is provided a computer-readable medium on which there is stored a computer program for processing a 2D image of an object under examination, in particular for enhancing the visualization of an image composition between the 2D image and a 3D image. The computer program, when being executed by a data processor, is adapted for performing exemplary embodiments of the above-described method.

According to a further aspect of the invention there is provided a program element for processing a 2D image of an object under examination, in particular for enhancing the visualization of an image composition between the 2D image and a 3D image. The program element, when being executed by a data processor, is adapted for performing exemplary embodiments of the above-described method.

The computer program element may be implemented as computer readable instruction code in any suitable programming language, such as, for example, JAVA, C++, and may be stored on a computer-readable medium (removable disk, volatile or non-volatile memory, embedded memory/processor, etc.). The instruction code is operable to program a computer or other programmable device to carry out the intended functions. The computer program may be available from a network, such as the WorldWideWeb, from which it may be downloaded.

It has to be noted that embodiments of the invention have been described with reference to different subject matters. In particular, some embodiments have been described with reference to method type claims whereas other embodiments have been described with reference to apparatus type claims. However, a person skilled in the art will gather from the above and the following description that, unless other notified, in addition to any combination of features belonging to one type of subject matter also any combination between features relating to different subject matters, in particular between features of the method type claims and features of the apparatus type claims is considered to be disclosed with this application.

The aspects defined above and further aspects of the present invention are apparent from the examples of embodiment to be described hereinafter and are explained with reference to the examples of embodiment. The invention will be described in more detail hereinafter with reference to examples of embodiment but to which the invention is not limited.

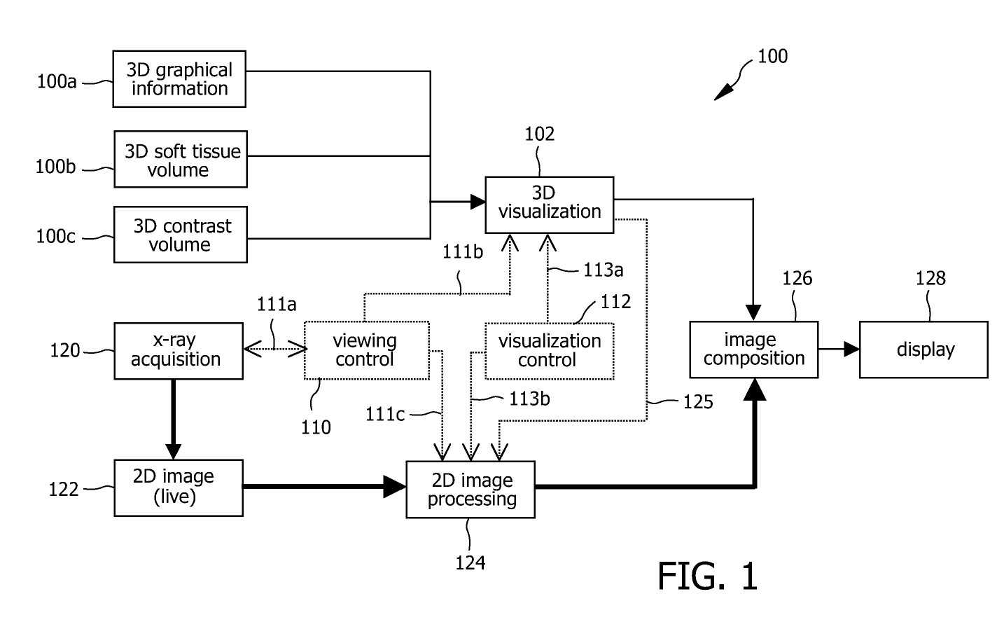

FIG. 1 shows a diagram illustrating a schematic overview of a 3D roadmapping visualization process comprising a spatial varying 2D image processing.

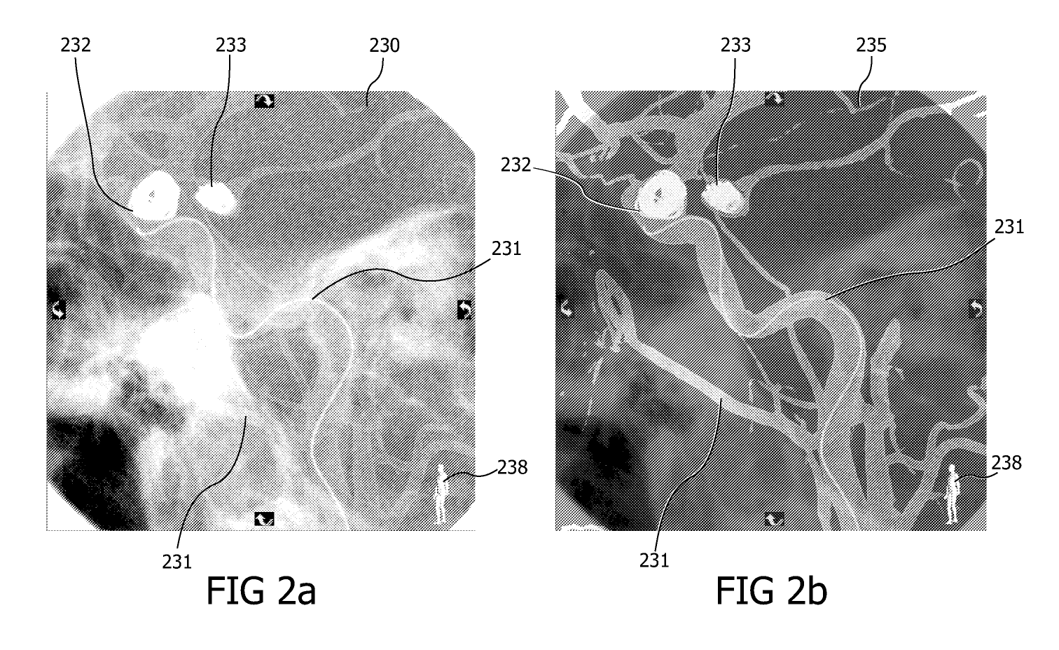

FIG. 2a shows an image depicting a typical roadmapping case of a vessel structure comprising a blending of a 2D image and a 3D image.

FIG. 2b shows an image depicting the identical roadmapping case as shown in FIG. 2a, wherein a spatial varying 2D image processing has been performed separately for regions representing the inside and regions representing the outside of the vessel lumen.

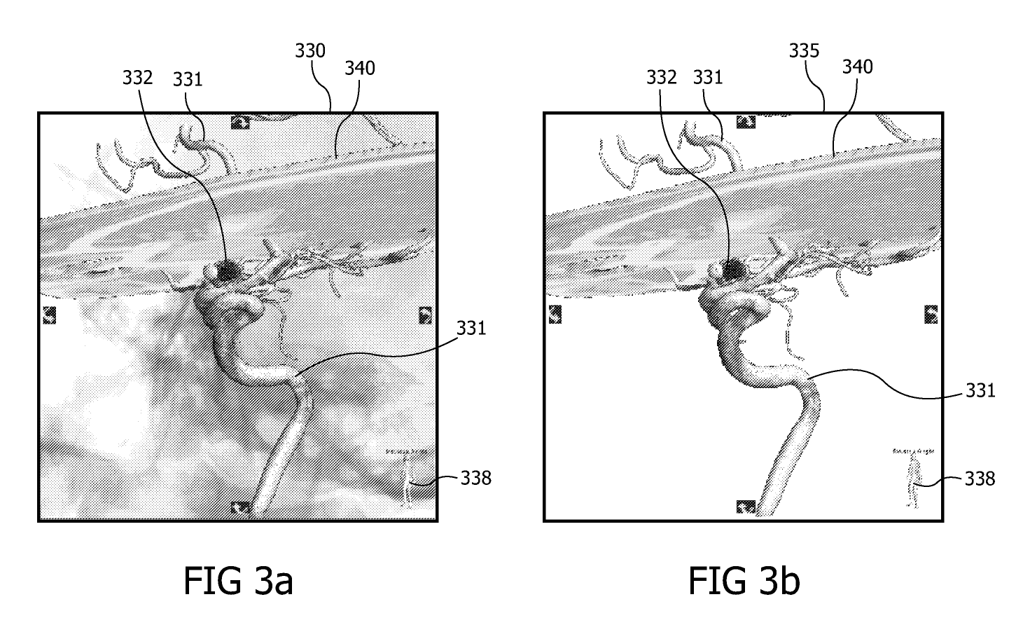

FIG. 3a shows an image depicting a typical roadmapping case of a vessel structure together with a test phantom.

FIG. 3b shows an image depicting the identical roadmapping case as shown in FIG. 3a, wherein a spatial varying 2D image processing has been performed separately for regions representing the inside and regions representing the outside of the vessel lumen.

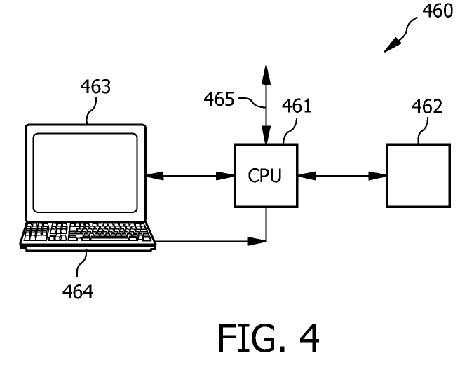

FIG. 4 shows an image-processing device for executing the preferred embodiment of the invention.

The illustration in the drawing is schematically. It is noted that in different figures, similar or identical elements are provided with the same reference signs or with reference signs, which are different from the corresponding reference signs only within the first digit.

FIG. 1 shows a diagram 100 illustrating a schematic overview of a visualization process comprising a spatial varying two-dimensional (2D) image processing. Within the diagram 100 the thick continuous lines represent a transfer of 2D image data. The thin continuous lines represent a transfer of three-dimensional (3D) image data. The dotted lines indicate the transfer of control data.

The visualization process starts with a not depicted step wherein a first dataset is acquired representing a three-dimensional (3D) image of an object under examination. According to the embodiment described here the object is a patient or at least a region of the patients anatomy such as the abdomen region of the patient.

The first dataset is a so-called pre-interventional dataset i.e. it is acquired before starting an interventional procedure wherein a catheter is inserted into the patient. Depending on the application the first dataset may be acquired in the presence or in the absence of a contrast fluid. According to the embodiment described here, the first dataset is acquired by means of 3D rotational angiography (3D RA) such that an exact 3D representation of the vessel tree structure of the patient is obtained. However, it has to be mentioned that the first dataset may also be acquired by other 3D imaging modalities such as computed tomography (CT), computed tomography angiography (CTA), magnetic resonance angiography (MRA) and/or 3D ultrasound (3D US).

From the first dataset there are obtained three different types of information. As indicated with reference numeral 100a, 3D graphical information is obtained from the first dataset. Further, as indicated with reference numeral 100b, information regarding the 3D soft tissue volume of the patient is obtained. Furthermore, as indicated with reference numeral 100c, information regarding the 3D contrast volume is obtained.

As indicated with reference numeral 120, a second dataset is acquired by means of a fluoroscopic X-ray attenuation data acquisition. The first dataset is acquired in real time during an interventional procedure.

As indicated with reference numeral 122, from the first dataset a live 2D fluoroscopic image is obtained.

In order to control a 3D roadmapping procedure there is further carried out a viewing control 110 and a visualization control 112.

The viewing control 110 is linked to the X-ray acquisition 120 in order to transfer geometry information 111a to and from an X-ray acquisition system such as a C-arm. Thereby, for instance information regarding the current angular position of the C-arm with respect to the patient is transferred.

Further, as indicated with the reference numeral 111b, the viewing control 110 provides control data for zooming and viewing on a visualized 3D image. As indicated with reference numeral 102, the 3D visualization of the object of interest is based on the 3D graphical information 100a, on the 3D soft tissue volume 100b and on the 3D contrast volume 100c, which have already been obtained from the first dataset.

Furthermore, as indicated with the reference numeral 111c, the viewing control 110 provides control data for zooming and panning on 2D data, which are image processed as indicated with 124.

As indicated with reference numeral 113a, the visualization control 112 provides 3D rendering parameters to the 3D visualization 102.

As indicated with reference numeral 113b, the visualization control 112 further provides 2D rendering parameter for the 2D image processing 124.

As indicated with reference numeral 125, the 3D visualization 102 further provides 3D projected area information for the 2D image processing 124. This area information defines at least two different regions within the live 2D image 122, which different regions have to be image processed in different ways in order to allow for a spatial varying 2D image processing.

As indicated with reference numeral 126, the 3D image obtained from the 3D visualization 102 and the processed live fluoroscopic image obtained from the 2D image processing are composed in a correct orientation with respect to each other. As indicated with reference numeral 128, the composed image is displayed by means of a monitor or any other visual output device.

FIG. 2a shows an image 230 depicting a typical roadmapping case of a vessel tree structure 231 comprising a blending of a 2D image and a 3D image. The image 230 reveals the positions of a first coil 232 and a second coil 233, which have been inserted into different aneurysma of the vessel tree 231. However, due to distracting background information of the live fluoroscopic image, which has been used for the roadmapping procedure, the image 230 exhibits shadowed regions. These shadowed regions reduce the contrast significantly.

FIG. 2b shows an enhanced image 235 depicting the identical roadmapping case as shown in FIG. 2a, wherein a spatial varying 2D image processing has been performed for regions representing the inside and regions representing the outside of the vessel lumen 231. The live fluoroscopic image, which has been used for the roadmapping image 230, has been image processed in a spatial varying way. Specifically, a guidewire enhancement procedure has been carried out for pixels located inside the vessel lumen 231 and a contrast respectively a noise reduction procedure has been carried out for pixels located outside the vessel lumen 231. Due to such a spatial varying 2D image processing the final roadmapping visualization is significantly less blurred as compared to the identical roadmapping case depicted in FIG. 2a. As a consequence, both the morphology of the vessel tree 231 and the coils 232 and 233 can be seen much more clearly.

Further, it has been avoided that overlaying graphics have been overwritten by the roadmap information like e.g. the view of the insert showing a person 238 and indicating the orientation of the depicted view. This means that according to the embodiment described here the remaining 2D image information overwrites only vessel information.

FIG. 3a shows an image 330 depicting a further typical roadmapping case of a vessel structure 331. Reference numeral 340 represents a cross-section of a 3D soft tissue volume (marking name XperCT), which has been created during the intervention. This image 330 reveals a fresh bleeding just above the aneurysma, which bleeding is indicated by the circular shaped region. The bleeding is caused by the coiling of the aneurysma. Again, the corresponding coil 332 can be seen which has been inserted into an aneurysma.

FIG. 3b shows an enhanced image 335 depicting the identical roadmapping case as shown in FIG. 3a, wherein a spatial varying 2D image processing has been performed for regions representing the inside and regions representing the outside of the vessel lumen 331. The used live fluoroscopic image has been image processed in a spatial varying way. Due to this spatial varying 2D image processing the final roadmapping visualization 335 is significantly less blurred as compared to the identical roadmapping case depicted in FIG. 3a. As a consequence, both the vessel tree 331 and the coil 332 can be seen much more clearly.

Further, the insert 338 shown in the lower right corner of the image 335 and indicating the orientation of the depicted roadmapping image 335 can also be seen much more clearly. This is based on the matter of fact that the processed 2D image only overwrites the vessel information of the corresponding view, which has been extracted from the 3D image.

FIG. 4 depicts an exemplary embodiment of a data processing device 425 according to the present invention for executing an exemplary embodiment of a method in accordance with the present invention. The data processing device 425 comprises a central processing unit (CPU) or image processor 461. The image processor 461 is connected to a memory 462 for temporally storing acquired or processed datasets.

Via a bus system 465 the image processor 461 is connected to a plurality of input/output network or diagnosis devices, such as a CT scanner and/or a C-arm being used for 3D RA and for 2D X-ray imaging. Furthermore, the image processor 461 is connected to a display device 463, for example a computer monitor, for displaying images representing a 3D roadmapping, which has been produced by the image processor 461. An operator or user may interact with the image processor 461 via a keyboard 464 and/or via any other input/output devices.

The method as described above may be implemented in open graphical library on standard graphics hardware devices using the stencil buffer functionality. During the view dependent display of the 3D information, as defined by the acquisition system, the stencil areas are created and tagged.

For performance reasons, the stencil information together with the rendered volume information may be cached and refreshed only in cases of a change of display parameters like scaling, panning and acquisition changes like C-arm movements. The live intervention information is projected and processed in multiple passes each handling its region dependant image processing as set up by the graphic processing unit.

It should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

In order to recapitulate the above described embodiments of the present invention one can state: An improved visibility for 3D roadmapping can be achieved by means of image coloring and other 2D-image processing procedures such as contrast/brightness settings, edge-enhancement, noise reduction and feature extraction, wherein these 2D-image processing can be diversified separately for multiple regions of pixels, such as inside and outside the vessel lumen.

### LIST OF REFERENCE SIGNS

100 diagram
100a obtain 3D graphical information
100b obtain 3D soft tissue volume
100c obtain 3D contrast volume
102 perform 3D visualization
110 execute viewing control
111a transfer geometry information
111b control zooming and viewing on 3D image
111c control zooming and panning on 2D data
112 execute visualization control
113a transfer 3D rendering parameter
113b transfer 2D rendering parameter
120 acquire second dataset
122 obtain live 2D fluoroscopic image
124 execute spatial varying 2D image processing
125 transfer 3D projected area information
126 compose image
128 display composed image
230 typical roadmapping image
231 vessel tree
232 first coil inserted in an aneurysma
233 second coil inserted in an aneurysma
235 enhanced roadmapping image obtained with spatial varying 2D image processing
238 insert indicating the orientation of the depicted roadmapping image
330 typical roadmapping image with test phantom
331 vessel tree
332 coil inserted in an aneurysma
335 enhanced roadmapping image with test phantom, the image obtained with spatial varying 2D image processing
338 insert indicating the orientation of the depicted roadmapping image
340 3D Soft Tissue (XperCT) cross-section
460 data processing device
461 central processing unit/image processor
462 memory
463 display device
464 keyboard
465 bus system

1. A method for processing a two-dimensional image of an object under examination, in particular for enhancing the visualization of an image composition between the two-dimensional image and a three-dimensional image, the method comprising the steps of
acquiring a first dataset representing a three-dimensional image of the object,
acquiring a second dataset representing the two-dimensional image of the object,
registering the first dataset and the second dataset and processing the two-dimensional image, whereby
based on image information of the three-dimensional image (125), within the two-dimensional image there is at least identified a first region (231, 331) and a second region being spatially different from the first region (231, 331) and
the first region (231, 331) and the second region are processed in a different manner.

2. The method according to claim 1, further comprising the step of
overlaying the three-dimensional image with the processed two-dimensional image.

3. The method according to claim 1, wherein
the first dataset is acquired by means of
computed tomography,
computed tomography angiography,
three-dimensional rotational angiography,
magnetic resonance angiography, and/or
three-dimensional ultrasound.

4. The method according to claim 1, wherein
the second dataset is acquired in real time during an interventional procedure.

5. The method according to claim 1, wherein
the step of processing the two-dimensional image comprises
applying different coloring,
changing the contrast,
changing the brightness,
applying a feature enhancement procedure,
applying an edge enhancement procedure, and/or
reducing the noise
separately for image pixels located within the first region (231, 331) and for image pixels located within the second region.

6. The method according to claim 1, wherein
the object under examination is at least a part of a human or an animal body, in particular the object under examination is an internal organ.

7. The method according to claim 6, wherein
the first region is assigned to the inside of a vessel lumen (231, 331) and the second region is assigned to the outside of a vessel lumen (231, 331).

8. The method according to claim 1, wherein
image information of the second region is removed at least partially.

9. The method according to claim 1, wherein
the contrast of the second region is reduced.

10. The method according to claim 1, wherein
the image information of the three-dimensional image is a segmented three-dimensional volume information.

11. A data processing device (460) for processing a two-dimensional image of an object under examination, in particular
for enhancing the visualization of an image composition between the two-dimensional image and a three-dimensional image,
the data processing device comprising
a data processor (461), which is adapted for performing the method as set forth in claim 1, and
a memory (462) for storing
the first dataset representing the three-dimensional image of the object and
the second dataset representing the two-dimensional image of the object.

12. A catheterization laboratory comprising
a data processing device (460) according to claim 11.

13. A computer-readable medium on which there is stored a computer program
for processing a two-dimensional image of an object under examination, in particular for enhancing the visualization of an image composition between the two-dimensional image and a three-dimensional image,
the computer program, when being executed by a data processor (461), is adapted for performing the method as set forth in claim 1.

14. A program element
for processing a two-dimensional image of an object under examination, in particular for enhancing the visualization of an image composition between the two-dimensional image and a three-dimensional image,
the program element, when being executed by a data processor (461), is adapted for performing the method as set forth in claim 1.
